(19) United States
(12) Patent Application Publication
(10) Pub. No.: US 2004/0069517 A1
(43) Pub. Date: Apr. 15, 2004

(54) Set screw type raintight threadless couplings & conncectors for electrical conduits

(76) Inventor: Mark H. Olson, South San Francisco, CA (US)

Correspondence Address: Joseph L. Strabala, Law Offices of Joseph L. Strabala, Suite 1020, One Embarcadero Center, San Francisco, CA, 94111, US

(21) Appl. No.: 10/421,398

(22) Filed: Apr. 23, 2003

Related U.S. Application Data
(60) Provisional application No. 60/417,015, filed on Oct. 9, 2002.

(51) Int. Cl. H02G 3/04

(52) U.S. Cl. 174/49

(57) ABSTRACT

A water tight fitting for joining electrical conduits without threads to other components includes a circular housing having a bore operable to receive the end of a conduit to be joined with another component by said fitting, at least one screw means associated with the fitting operable to engage the end of a conduit inserted in such bore to lock the same in said fitting, at least one compression means having an aperture enabling it to freely slide over such conduit and operable to engage the housing to advance the compression means axially along such conduit received in the housing, and sealing means positioned between the compression means and the housing operable to effect a water tight seal between the housing and such conduit when the compressing means compresses the sealing means against the housing as it axially advances in the housing. In one embodiment the set screw means is located in the compression means and in another it is located in the housing where it includes sealing means between the set screw and the housing.

### BACKGROUND OF THE INVENTION

Various conduits are employed in electrical installation in buildings, exterior walls of buildings and similar structures, which are typically, Electrical Metallic Tubing [EMT], Ridge Metal Conduit [RMC], Intermediate Metal Conduit [IMC], and Aluminum Ridged Conduit [AL RC] conduits. Such conduits are sold in various lengths, usually about 10 feet, and in the field are cut to the desired length for installation where the conduits are connected to junctions boxes or connected end to end to achieve a longer conduit run or to elbows or the like.

To connect such conduits end to end, couplings are required; to connect such conduits to junction boxes connectors are used. Such couplings and connectors can be purchased from various suppliers stocking such parts. Currently available, couplings and connectors for EMT, RMC, IMC and AL RC conduits, are illustrated for conduit sizes from ½ inch to 4 inch, up to 6 inch for some conduits, in the National Electrical Code Handbook which is published every three years.

Since it is difficult to put pipe threads on the ends of the conduits in the field or on thin wall conduits, many installations of these conduits use “threadless” couplings and connectors to join them to other conduits or junction boxes, respectively. For each of the conduits, EMT, RMC, IMC and AL RC conduits, the specifications in the handbook for threadless couplings and connectors for such conduits are:

“a) Threadless. Threadless couplings and connectors used with conduit shall be made tight. Where buried in masonry or concrete they shall be concrete tight. Where installed in wet locations they shall be the raintight type.”

There are basically two general types of threadless couplings and connectors (collectively fittings) available. One is the compression type using nuts to lock the conduit in the fitting by compressing a slip ring against the conduit in the fitting and the other employs set screws to lock such conduits into the fitting. The current invention relates to the second type, the couplings and connectors employing set screws to lock the conduits in such fittings.

Applicant, an electrical contractor, has tested the available threadless couplings and connectors of the set screw type available in the industry by closing off (sealing) one end or a short piece of conduit joining another piece of conduit to it with a coupling and submerging the short piece of conduit and coupling in a pool of water. None of the commercially available couplings were raintight based on these tests; that is, the short piece of conduit and coupling filled with water in a short period of time. A similar test was done with commercially available connectors of the set screw type; none of these commercially fittings were found to be raintight.

In part, water ingress results from variations in the outside diameter of the conduits and variations in the inside diameter of the couplings or connectors, which in larger conduit size installation can result in gaps in the range of 0.060 inch between the outer diameter of the conduit and these fittings.

On hundreds of thousands of roofs on commercial buildings, exterior walls and in industrial plants EMT, RMC, IMC and AL RC conduits are installed with threadless couplings and/or connectors which are not raintight even though the specifications for these installations more often than not require that the threadless couplings or connectors emplopyed should be “listed” as raintight.

While rain is essentially distilled water, once it contacts a metal conduit it dissolves metal atoms, along with other impurities, and becomes conductive when it enters the interior of such conduits through a coupling or connector which is not raintight. As such water passes through the interior of the conduit system it absorbs more impurities and may short out electrical circuits, switch gear and the like. Of course corrosion from the intrusion of the rain water compromises such installation still further. For these reasons engineers specify that raintight threadless coupling and connectors for such conduits be used in wet locations, such as the roofs and exteriors of buildings. The problem is that almost all commercially available connectors and couplings for conduits in wet locations are not raintight with the exception of the connector/coupling with a elastomer boot illustrated in U.S. Pat. No. 3,951,436. These connectors/couplings are generally unsatisfactory due the ultra violet (UV) degradation of the boot, after which water intrusion can be extensive. Moreover the exposed boot is subject to damage during installation which can lead its failure to prevent the ingress of water, e.g., contact with the sharp end of a conduit being inserted or tools used for installing and/or mounting conduits. As a result boots are not often used in such installations. In addition, rubber covers have been employed over the ends of coupling and connectors which are slipped on ends of the these fittings after the conduits have been secured in the fitting having been previously placed on the conduit, see for example U.S. Pat. No. 6,106,031 illustrating plastic end caps and an O-ring which placed in a recess between the conduit and the fitting to effect a seal without compression of the O-ring. Such covers also may provide some temporary sealing if the aperture in the cover is of a lesser diameter than the outside diameter [OD] of the conduit but such a seal may be short lived due to UV degradation, mechanical displacements and/or mechanical damage to the O-ring. Another coupling/connector design is illustrated in U.S. Pat. No. 5,165,735 which uses a un-compressed sealing washer to assist in reducing water intrusion into such fittings. Due to the ability of the washer to shift in the fitting and mechanical damage to the washer when the sharp end of a conduit is inserted, it may or may not be raintight initially and/or may ultimately not provide a raintight connection. More often than not, covers or caps provide only temporary sealing against water intrusion which is short lived due to UV degradation and/or mechanical displacements.

An object of applicant's invention is provide set screw couplings and connectors for the industry which are raintight.

A further object is to provide such couplings and connectors, which are superior to those currently available in the industry.

Still another object is to provide couplings and connectors which are economical to produce so that installations in wet locations can employ threadless raintight couplings and connectors without a significant increase in cost over similar non-raintight couplings and connectors now sold in the market place.

Another object of this invention is to provide improved raintight couplings and connectors which ensure a continuous and adequate electrical ground through these fittings.

Other objects and advantages will be apparent form the specification which follows and the drawings accompanying this application.

### SUMMARY OF THE INVENTION

Set screws are used to lock conduits in couplings and connectors (fittings) but these available fittings are not raintight. Applicant has undertaken to improve such fittings by providing modifications which converts these fittings to raintight fittings by effecting a seal between the coupling or connector using o-rings or the like which are compressed between a conduit and the fitting to form a seal and locking the conduit or conduits in the fitting with set screws which have separate sealing elements or are located outside the seal between the fitting and the conduit.

More specifically the objects and advantages of this invention can be accomplished by a water tight fitting for joining electrical conduits to other components without threads on the conduits which includes a circular housing having a bore operable to receive the end of a conduit to be joined with another component by said fitting, at least one screw means associated with the housing operable to engage the end of a conduit inserted in such bore to lock the same in said fitting, at least one compression means having an aperture enabling it to freely slide over such conduit and operable to engage the housing to advance the compression means axially along such conduit received in the housing, and sealing means positioned between the compression means and the housing operable to effect a water tight seal between the housing and such conduit when the compressing means compresses the sealing means as it advances axially along the housing. In one embodiment the set screw means is located in the compression means and in another it is located in the housing.

### DESCRIPTION OF THE DRAWINGS

FIG. 1 is perspective of a prior art coupling employing set screws to lock conduits in the coupling;

FIG. 2. is a perspective of a prior art connector using set screws to lock conduits in the connector;

FIG. 3 is a section of a connector according to this invention employing sealing washers with each set screw and a nut to force an o-ring into a recess in the end of the connector to effect a seal between a conduit in the connector;

FIG. 4 is an elevation of a coupling for joining two pieces of conduit using the o-ring sealing features shown in FIG. 3 for the novel connector shown therein;

FIG. 5. is a section of another embodiment of the novel connector of this invention using sealing washers with each set screw and a bushing nut operable to force an o-ring into a recess in the end of the connector to effect a seal between a conduit in the connector and the connector;

FIG. 6 is a section of a coupling for joining two pieces of conduit using the features shown in FIG. 5 for the novel connector illustrated therein;

FIG. 7 is a modification of the connector illustrated in FIG. 3 employing a quick attachment nut to effect a seal with the o-ring;

FIG. 8 is a section of a coupling for joining two pieces of conduit using the features shown for the novel connector in FIG. 7;

FIG. 9 is a section of a connector of this invention employing a bushing nut as shown in FIG. 8 to effect a o-ring seal and employing set screws in the nut outside of seal area;

FIG. 10 is a section of a coupling for joining two pieces of conduit using the features shown in FIG. 9 for the novel connector shown therein;

FIG. 11 is a modification of the connector illustrated in FIG. 9 employing a collar nut, in place of bushing nut to effect a seal with the o-ring; and

FIG. 12 is a section of a coupling for joining two pieces of conduit using the features shown for the novel connector in FIG. 11.

### THE PRIOR ART

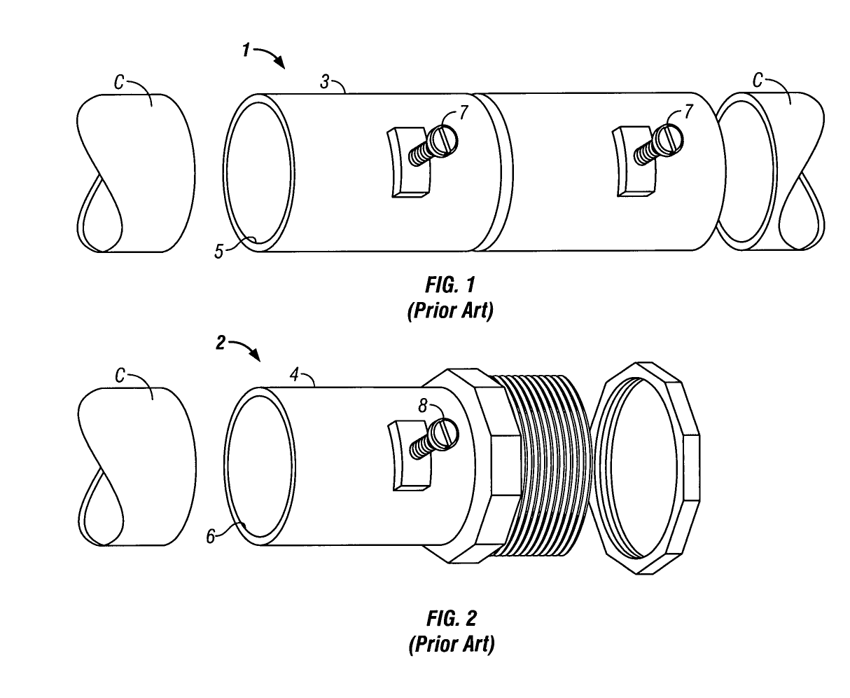

FIG. 1 illustrates a prior art coupling 1 and FIG. 2 illustrates a prior art connector 2. In the parlance of the trades, a threadless coupling 1 is used to join conduits end to end while a threadless connectors 2 is used to join conduits to junction boxes or the like.

In these figures it can be seen that in both the coupling 1 and the connector 2, the fittings, have a hollow cylindrical housing 3 and 4 respectively with bores in the housing of which the internal diameter is sized so that it will receive the outer diameter of an electrical conduit C, of the size for which the fitting is made so the end of such a conduit will fit into the ends 5 and 6 respectively of the housings of these fittings.

After conduits are inserted into the ends of the housing of the coupling, set screws 7 on the housing 3 are advanced until the their distal ends abut against the conduits C with sufficient pressure to lock the ends of the conduits in the coupling. In larger size conduits, 1 inch diameter and up, multiple set screws (not shown) are often used in the coupling and at each end to achieve a good mechanical lock and ensure adequate electrical continuity through the coupling.

The end of conduit C is secured in the same fashion in the connector 2 by a set screw 8 once it is received in the housing 4. The conduit can be secured in the housing of connector before or after the connector is secured in a junction box (not shown) or the like by inserting its threaded boss 9 into an aperture in the box and thereafter assembling the lock nut 10 on the boss. Often a rubber washer or similar selling element (not shown) is placed over the boss before it is inserted in the box whereby a seal between the box and the connector will be effected when the nut is advanced on the boss and the flange on the connector is tightened against the inner surface of the box.

As noted above these fittings are not raintight, due to the facts that the outer dimensions of the conduits and the inner dimensions of the fittings vary considerably leaving openings for the ingress of water.

As noted coupling 1 may have two, or more set screws at each end instead of one, and a connector 2 may have two, or more set screws instead of one shown in FIG. 2.

### DISCRIPTION OF THE INVENTION(S)

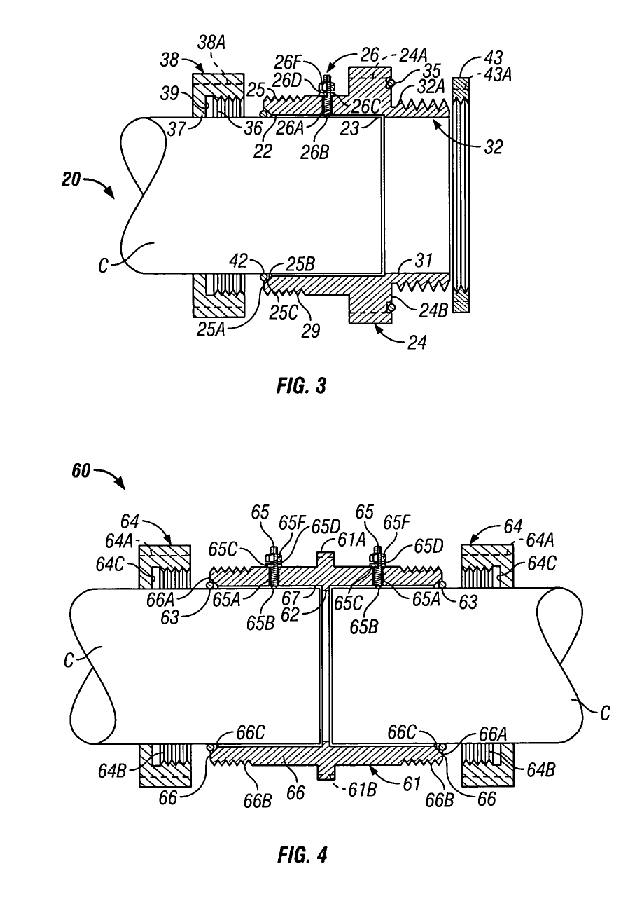

In FIG. 3 one embodiment of the novel connector 20 according to this invention is illustrated. It includes a hollow housing 21 which has a central bore 22 sized to receive an end of a conduit. The connector also includes a hollow threaded boss 32 which extends from one end 33 of the housing for joining the connector to a junction box [not shown] or the like. This boss 32 is provided with external threads 32A.

In this connector 20, the housing 21 has a radial flange 24 which includes wrench flats 24A. The wrench flats 24A enable the connector to be easily stabilized with a wrench when it is being assembled with a conduit or installed in a junction box. As the flange is contiguous to the boss 32 its face 24B will abut against a junction box [not shown] when the boss passes through an aperture therein. This flange can include an O-ring 35 on its face which will abut against the surface of the box when the connector is assembled therewith. In place of the O-ring, an elastomer washer (not shown) or a preformed seal member in the face of the flange (not shown) can be substituted for the O-ring. The connector is secured in the box with a lock nut 43 which is applied to the boss from inside the box and then tightened to secure the connector in the box and effect a seal between the box and the connector when the O-ring 35 or an equivalent sealing member is located between the flange and the box.

The hollow housing 21 of the connector 20 has a central bore 22 adapted to receive the outside diameter [OD] of a conduit C. As the bore 31 in the boss 32 is slightly smaller than the co-axial central bore 22, there is a step 23 at their conjunction which forms a stop for the end of conduit inserted into end 25 of the connector. At this end of the connector a radial face 25A is provided which is normal to the axis of the bore 22 and a 45 degree relief 25B is also provided at the conjunction of the central bore 22 and the face for compressing an O-ring. Obviously the recess is not restricted to a 45 degree bevel which is merely illustrative of a relief that can be used to constrain an O-ring or similar sealing element. External threads 25C are provided on the end 25 of the connector.

As can be seen in FIG. 3 a collar 38 is located at an end 25 of the connector 20. This collar has a bore 37 which is large enough to slip over the OD of a conduit C for which the connector is designed and is slipped onto the end of the conduit before the end of the conduit is inserted into the housing. A radial compression face 39 is formed by providing a co-axial secondary bore 38A in the collar which is larger than the bore 37. Typically the compression face 39 is normal to the axis of these bores and the secondary bore 38A is provided with internal threads 36. Wrench flats 38B are located on the periphery of the collar for tightening the collar on the housing.

An O-ring 42 is assembled on the conduit C after the collar 38 has been slipped onto the conduit so it is located between the compression face 39 of the collar and the relief 25B in the housing at the conjunction of the central bore and the face 25A. As the collar is advanced by engagement of its internal threads 36 with the external threads 29 on the housing 21, its compression face 39 will ultimately engage the end 25 of the housing as the O-ring is driven into the relief 25B which forces it radially against the OD of a conduit to effect a raintight seal between the housing and the conduit C. Of course, other sealing devices can be used in place of the more conventional O-ring. Once the compression face 39 abuts against the end of the housing, the axial advance of this collar stops, preventing damage to the O-ring after sufficient compression occurs to form the required seal.

As can be seen in FIG. 3, a set screw 26 is located on the hollow housing 21 of the connector 20 and includes a hexagonal aperture so that it can be turned with an allen wench. It is disposed in a threaded bore 26A in the housing and as it is advanced in this bore by rotating the set screw, its distal end 26B will ultimately engage the conduit C to secure it the connector. While only a single set screw is shown, multiple set screws may be employed, especially for connectors for larger diameter conduits, one inch and larger.

Once the set screw 26 secures the conduit in the housing, a rubber sealing washer 26C is placed on the set screw followed by a metal washer 26D. Thereafter a nut 26E is advanced on the threaded set screw, compressing the rubber sealing washer 55 against the housing 21 and causing it to engage the set screw to effect a raintight seal between the set screw and the housing. Other types of set screws can be used in place of the one illustrated and other types of sealing arrangements can be used to ensure there is no leakage around the particular set screw employed, without departing from the spirit of the this invention, such nylon inserts in the bore receiving the set screw (not shown). Also a designed mechanical interference between the set screw and its bore may provide a seal.

In FIG. 4 a coupling 60 is illustrated employing some of the features described for the connector 20 above, which includes a cylindrical housing 61 which receives the ends of two separate pieces of conduit C to join them together end to end.

In this coupling 60 its hollow housing 61 has a central bore 67 adapted to receive the respective ends of conduits being joined with the coupling. A central stop 62 is formed in the middle of this bore, usually by an integral flange extending into this bore in the middle of the housing, against which the ends of conduits will abut when inserted from opposite ends of the coupling. Other types of stops can be employed, such as a snap ring in a groove in this bore. Centrally located on the exterior of the housing is a flange 61A with raised wrench flats 61B which enable the coupling to be easily stabilized with a wrench when it is being assembled with conduits.

Parts of this coupling include O-rings 63, collars 64, and set screws 65, which function in the same manner as previously described for the connector 20, in this regard, external threads 61B are provided at each end 66 of the housing. A 45 degree relief 61C is provided at the conjunction of the central bore 67 and the adjacent radial face 66A.

As can been seen in FIG. 4, as each collar 64, is axially advanced by engagement of its internal threads 64B with the external threads 61B of the housing, the compression face 64C of the collor is forced against the radial face 66A of the housing, as the O-ring 63 is driven into the relief 66C to effect a seal between the housing and the conduit.

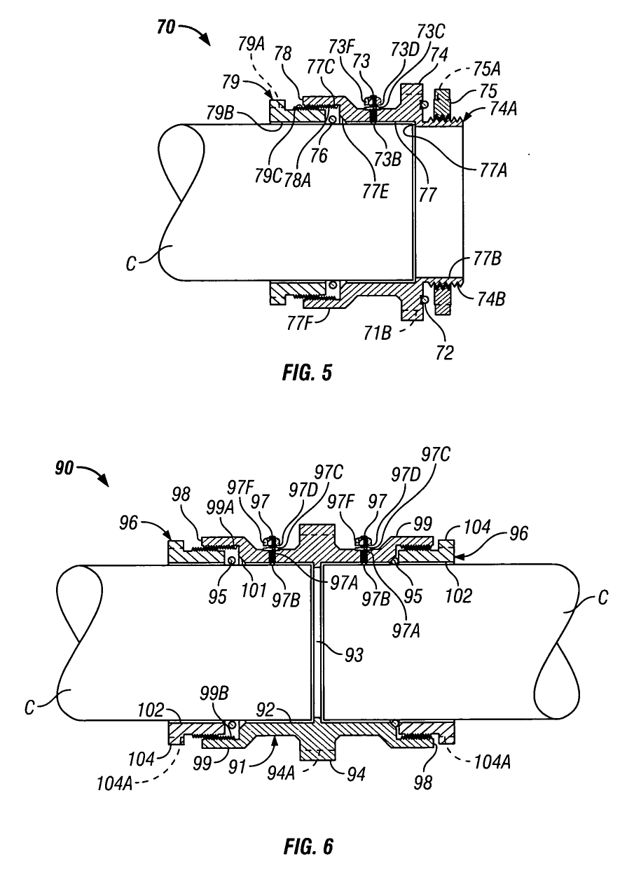

The set screws 65 illustrated in FIG. 5 function the same as the set screw 26 shown in FIG. 4, that is these set screws are received in threaded bores 65A in the housing and advanced until the distal ends 65B of these set screws press against the respective conduits to secure them in the housing 61 and preventing these conduits from moving in the coupling. It can be appreciated from the prior description that each collar 64 and its associated O-ring 63 are assembled on the respective conduits C before the respective ends of the conduits are inserted into the coupling 60. Screwing the collars onto the opposite ends of the coupling will compress their associated O-rings between the conduit on which they have been assembled and the housing, effecting a raintight seal between the coupling and the several conduits.

Another embodiment of the invention is connector 70 illustrated in FIG. 6, which reverses parts of the embodiment shown in FIG. 5 by employing internal threads in the housing and external threads on the collar.

More specifically, the connector 70 employs a housing 71 which has a radial flange 74 which includes wrench flats 71B. Projecting from the flange is a hollow boss 74A which includes external threads 74B. This boss is used to connect the connector to a junction box or the like (not shown) by inserting the boss into an aperture in the box and then screwing the lock nut 75 onto the boss from inside the box. When the nut is tightened on the boss, the O-ring 72 on the radial face of the flange engages the box in a sealing relationship. A washer (not shown) or a preformed sealing member (also not shown) may be used in place of the O-ring.

Housing 71 has a central bore 77 adapted to receive the OD of a conduit C. As the bore 77B in the boss is slightly smaller than the co-axial central bore 77, there is a step 77A at their conjunction which forms a stop for the end of conduit inserted into this connector. One end of the connector is belled and has a larger secondary bore 77C co-axially aligned the other bores in the connector, leaving a shoulder 77D at their conjunction. In the end 78 of the connector internal threads 78A are formed. Typically the face 77F of the shoulder is normal to the axis of these bores and a 45 degree relief 77E is provided at the conjunction of the central bore 77 and the face 77F on the shoulder 77D.

The collar 79 has external threads 79C and a bore 79B which is large enough to slip over the OD of a conduit for which the connector is designed. Wrench flats 79A are located on the flange on the exterior end of the collar for turning it.

An O-ring 76 is located on the conduit between the compression face 79F of the collar and the relief 77E at the shoulder 77D. As the collar 79 is advanced by engagement of its external threads 79C with the internal threads 78A of the connector, the compression face 79F will abut against the face 77F, after the O-ring is driven into the relief 77E which forces it radially against the OD of a conduit to effect a seal between the housing and this conduit. Of course, other sealing devices can be used in place of the more conventional O-ring illustrated. Once the compression face 79F abuts against the face 77F, its axial advance stops, preventing damage to the O-ring after a set amount of compression occurs.

FIG. 6 a coupling 90 is illustrated employing the features described for the connector 70 above, which includes a housing with opening at each end to receive conduits which are to be joined end-to-end.

Like the connector 70, the coupling 90 includes a hollow housing 91 which has a central bore 92 adapted to receive the ends of conduits being joined with the coupling. A central stop 93 is formed in the middle of this bore, usually by an integral flange extending into this bore, against which the ends of conduits will abut when inserted from opposite ends of the housing. Other types of stops can be employed. Centrally located on the exterior of the housing us a flange 94 having wrench flats 94A which enable the coupling to be easily stabilized with a wrench when it is being installed on conduits.

This coupling, including O-rings 95, threaded collars 96, and set screws 97, which function in the same manner as previously described for the connector 70.

At each end 98 of the coupling a bell shaped portion 99 is provided having a bore 99A which is coaxial with and larger than the bore 92 in the housing. Internal threads 99B are formed in this bore. Where this bore meets the bore in the housing, a radial face 100 is formed and a 45 degree relief 101 is provided at the conjunction of this face and the central bore in the housing.

As can be seen in FIG. 6, an externally threaded collar 96 is used at each end 98 of the connector 90 each of which has a bore 102 which is large enough to slip over the OD of a conduit for which the connector is designed and external threads 103 at one end and a flange 104 at the other end with wrench flats 104A.

At each end 98 of the connector 90, an O-ring 95 is located on the conduit C between the end 105 of each of the collars 96 and their adjacent reliefs 101. As a collar 96 is advanced by engagement of its external threads with the internal threads 99B of the housing, its end 105 eventually abuts against the radial face 100 in the housing, after the O-ring is driven into the relief 101 which forces it radially against the OD of a conduit C to effect a seal between the housing and the conduit. Of course, other sealing devices can be used in place of the more conventional O-rings.

When the ends 105 of the collars 96 abut on their respective faces 100 in the housing, the axial advance of the collars stop, preventing damage to the O-ring after a set amount of compression occurs.

The rain-tight set screws 97 in FIG. 6 function similarly to the set screws 26 illustrated in FIG. 4 in that each screw is placed in a threaded bore 97A and advanced until its the distal end 97B presses against the conduits in the housing 91 with sufficient force to secure the conduits C therein and preventing them from moving in the housing. To effect a seal, a rubber washer 97C is assembled on each set screw after it is tightened against its associated conduit, followed by a metal washer 97D and a nut 97F which is advanced on the set screw to compress the rubber washer against the housing and extrude it against the set screw to effect a raintight seal.

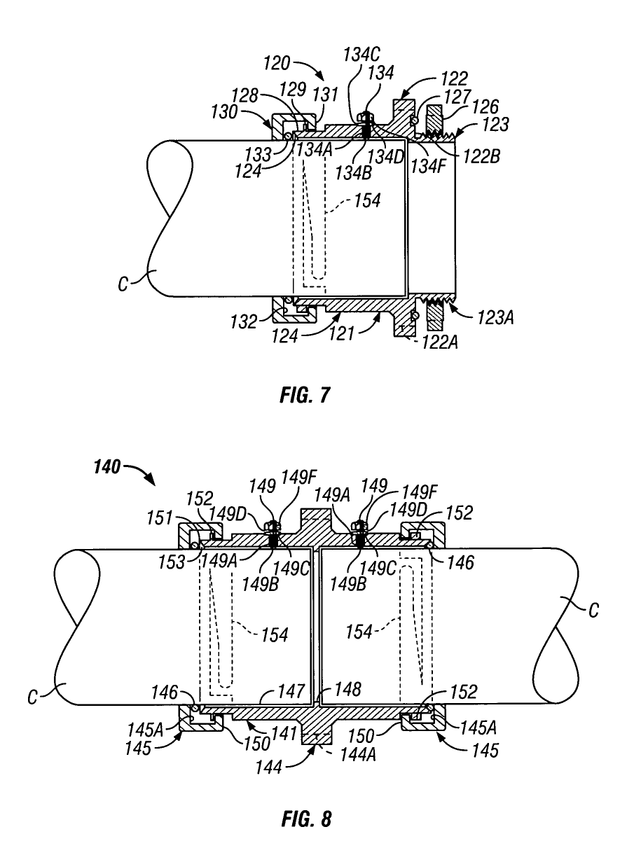

FIG. 7 shows a embodiment of the invention which employs a quick sealing nut or collar which enables it to be assembled much faster, thereby saving labor costs when it is employed. More particularly, the connector 120 has a cylindrical housing 121 which is similar to the housing of the connectors previously described. It includes a flange 122 at one end 123 having a hollow boss 124 extending therefrom on one side and a cylindrical sleeve portion 125 on the other. The flange includes wrench flats 122A and the boss includes external threads 123A. A nut 126, with wrench flats 126A, can be assembled on these threads to join the connector to a junction box (not shown) in the manner previously described for the other connectors discussed above. Likewise an O-ring 127, or other sealing device, is provided on the radial face 122B of the flange which effects a seal when the connectors is assembled with a junction box, compressing this O-ring.

At the end 128 of the sleeve portion 124, the male threads 129 of an interrupted screw arrangement are provided along with a recess 124A which is shown as a 45 degree bevel. The collar 130 has the female components 131 of this interrupted screw arrangement enabling the collar to be received on the end of the sleeve portion of the housing and turned a quarter turn to bring its radial face 132 into engagement with the end 128 of the housing. When this occurs an O-ring 133 will be simultaneously driven into the recess 124 effecting a raintight seal between the housing and conduit C. Since the conduit is secured in the housing by one or more set screws 134 the collar need not develop much force as it advances on the interrupted screw to compress the O-ring as described above.

Like the previous connectors one or more set screws 134 retain the conduit C in the housing 121. This is accomplished by advancing a set screw in its threaded bore 134A until its distal end 134B engages conduit C with sufficient force to lock this conduit in the housing. The seal about the set screw is formed in the same manner as previously described, by putting a rubber washer 134C on the set screw followed by a metal washer 134D and a nut 134F which is advanced on the set screw until the rubber washer effects a raintight seal between the housing and the set screw.

In FIG. 8, a coupling employing the interrupted screw arrangement is shown. This coupling 140 has a housing 141 which is tubular having a bore 142 with a central stop 143 which forms a stop for the ends of conduits C inserted into the coupling. A flange 144, with wrench flats 144A, is centrally located on the housing and provides a means to stabilize the housing when it is being assembled with the conduits. Before the ends of the conduits are inserted into the housing, a collar 145 is slipped onto each conduit followed by an O-ring 146. Thereafter the ends of the respective conduits are inserted into the bore 147 of the housing until their respective ends hit the stop 148 centrally located in the bore. With ends of the conduits against this stop, set screws 149 are advanced in their respective threaded bore 149A until their respective distal ends 149B engage their associated conduit with sufficient force to lock these conduits in the housing 141. As previously described, after the set screws are tightened, a rubber washer 149C is placed on each set screw followed by a metal washer 149D and then a nut 149F which is tightened on the set screw to effect a raintight seal between each set screw and the housing. Multiple set screws can be used even though only two are illustrated.

Once the conduits C are locked in the housing, each collar 145 having one part 150 of the interrupted screw arrangement is advanced to the end 151 or the housing 141 where the other part 152 of the interrupted screw arrangement is formed. As each collar is tightened on the interrupted screw, its radial face 145A will pushes the O-ring 146 axially along the conduit C to the recess 153 formed about the mouth of the bore 147 in the housing at each end. Each recess or bevel is typically formed at 45 degrees relative to the bore axis. By rotating the collar a quarter or a half of a turn, the O-ring will be driven into the recess creating a seal between the housing and the conduit the collar encircles. As indicated this embodiment saves labor in that the interrupted screw arrangement indicated by broken lines 154 in FIGS. 7 and 8 enables an installer to assemble the collars quickly as they only accomplish a seal as opposed to structurally connecting the conduits to the coupling.

It should be appreciated that the interrupted screw arrangement can be used on the embodiments of the invention shown in FIGS. 5 and 6 in place of the threaded collars illustrated in those drawings. In addition, it is with the contemplation of this invention that instead of the collars described, a simple disk (not shown) having an aperture large enough to fit over the conduit for which the fitting is designed with bolt holes surrounding the aperture and bolts which fit into threaded bores in the end of the housings, can be used to compress an O-ring in one of recesses as previously described.

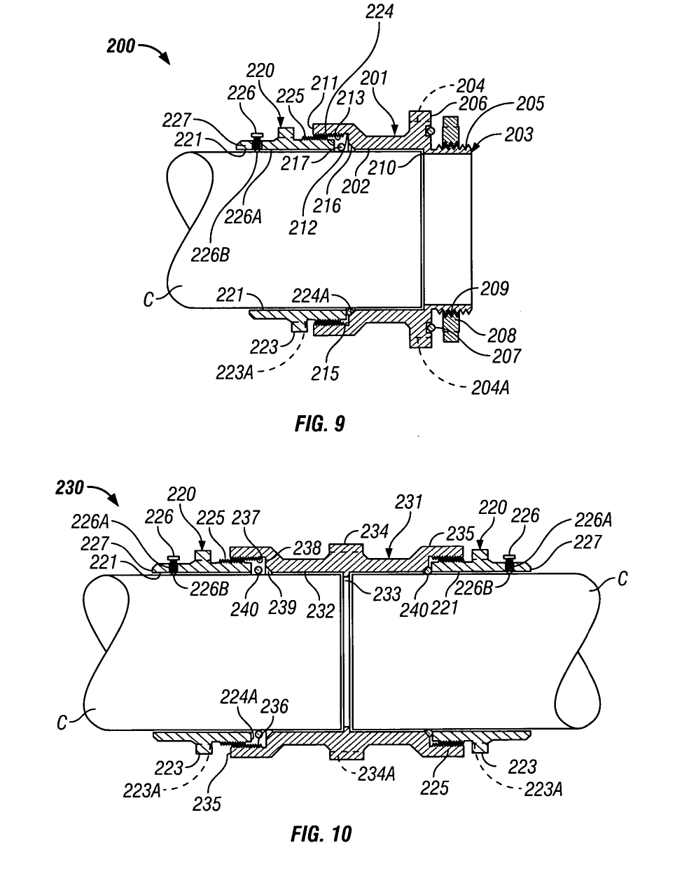

FIG. 9 shows an alternate embodiment of the invention, illustrating a connector 200 in which a set screw (or screws) is placed outside the seal between its housing and the conduit. Providing a set screw on the collar in this manner makes use of rain-tight set screws unnecessary. Note that providing a set screw on the collar in this embodiment requires that the collar be tightened on its housing before tightening the set screw (or screws) against the conduit C.

More specifically, the connector 200 includes a hollow housing 201 which has a central bore 202 sized to receive an end of a conduit C. The connector also includes a hollow threaded boss 203 which extends from a radial flange 204 on the housing. The boss is used for joining the connector to a junction box [not shown] or the like and is provided with external threads 205 for this purpose.

The radial flange 204 includes wrench flats 204A. The wrench flats enable the connector to be easily stabilized with a wrench when it is being installed in a conduit or a junction box. This flange has radial face 206 which the housing is contiguous to the boss 203 and that abuts against a junction box [not shown] when its boss passes through an aperture therein. As shown in FIG. 9, the face includes an O-ring 207 which will abut against the surface of the box when the connector is attached with nut 208, having wrench flats 208A. This nut is applied to the boss from inside the box and then tightened to secure the connector to the box and effect a seal between the box by compressing the O-ring against the surface of the box. An elastomer washer (not shown) or a preformed seal member (not shown) can be used in place of an O-ring which is illustrated, without departing from the spirit of this invention.

The hollow housing 2010f the connector 200 has a central bore 202 adapted to receive the outside diameter [OD] of a conduit C. As the bore 209 in the boss is slightly smaller than the co-axial central bore, there is a step 210 at their conjunction which forms a stop for the end of a piece of conduit inserted into the connector. At the end 211 of the connector the housing is belled outwardly to a larger, coaxial diameter 212 which includes internal threads 213 as can be seen in FIG. 9. Where this larger diameter joins the smaller bore 202 a radial face 215 is provided which is normal to the axis of the bore 202. A 45 degree relief 216 is provided at the conjunction of the central bore 210 and this face for receiving an O-ring 217. External threads 214 are provided on the exterior of the end 113 of the housing.

As can be seen in FIG. 9 a collar or bushing 220 is used at an end 211 of the connector 200. The collar has a bore 221 which is large enough to slip over the OD of a conduit C for which the connector is designed. This collar has central wrench flange 223 that has wrench flats 223A for rotating the collar when is screwed into the connector. For this purpose the surface of the collar between the wrench flange and its end 224 has external threads 225. This end is provided with a radial compression face 224A.

As can be seen in FIG. 9, the O-ring 217 is located between the compression face 224A of the collar and the relief 216 at the mouth of the central bore. As the collar is advanced by engagement of its external threads 225 with the internal threads in bore 212 of the connector, the radial face of the collar force the O-ring into the relief 216 compressing its against the OD of a conduit in the fitting, creating a seal between the housing and the conduit. Of course, other sealing devices can be used in place of the more conventional O-rings and this invention is not restricted to the use of O-rings as the primary sealing device. Once the radial face abuts against the face 215 of the housing 201, the axial advance the collar is stopped. preventing any damage to the O-ring after a set amount of compression has occurred.

The external threads 225 on the collar and the internal threads in bore 212 of the housing 201 have an interference fit, similar to pipe threads. Thus when the collar is tightened in the housing the collar will not back out of the housing unless considerable torque is applied.

With the conduit C in the connector 200 as shown in FIG. 9 and the collar 220 screwed into the housing 201 to effect a seal between conduit C and the housing as described above, a set screw or set bolt 236 is inserted in a threaded bore 226A in the distal end 227 of the housing. Additional set screws or set bolts can be employed and each is tightened by advancing them in their respective bores until their distal ends 226A engage a conduit in the connector and lock it in place.

In FIG. 10 a coupling 230 is illustrated which employs the same collars 220 as previously described with reference to the connector 200 illustrated in FIG. 9 but with a different housing for the coupling which is used to join conduits of the type described end to end. As these collars are identical they will not be described again.

The coupling 230 illustrated in FIG. 10 includes a hollow cylindrical housing 231 having a central bore 232 which is divided by a central stop 233, It also has a raised central wrench flange 234 which includes wrench flats 234A for securing the coupling when it is assembled with conduits C.

Bells 235 are formed at the opposite ends of the housing which have a bore 236 with a larger diameter that the central bore 232 and internal threads 237. At the conjunctions the central bore with bore in the bells, a radial face 238 is provided in the housing and a 45 degree relief 239 is fashioned at the mouths of the central bore.

As can be seen in FIG. 10 an O-ring 240 is placed on the conduit C after the collar 220 has been slid onto the conduit, after which each of the ends of the conduits are slid into the central bore 232 until they hit the stop 233. Thereafter each collar is screwed into the housing with its radial face 224A driving its associated O-ring into one of the recesses 239 compressing it against the conduit to create a seal. The right end of the coupling shown in FIG. 10 shows the collar advanced in the manner described, with the O-ring compressed.

Once both pieces of conduit C are in the coupling 230 and the collars 220 tightened sufficiently to cause the O-ring to create a raintight seal between them and the housing 231, set screws or set bolts 226 are tightened so that their respective ends 226B engage the respective conduits to lock them in the coupling. As mentioned above the threads between the housing and the collars are of the interference type and will not creep after collars are tightened. Thus the set screws or set bolts will securely lock the conduits in the coupling and there is no need to provide sealing means around the set screws as positive seal exists upstream of these screws.

It should be appreciated that sealing means, other than O-rings illustrated, can be employed with the connector and coupling, and that multiple set screws or set bolts will normally be used with these fittings are designed for larger size conduits.

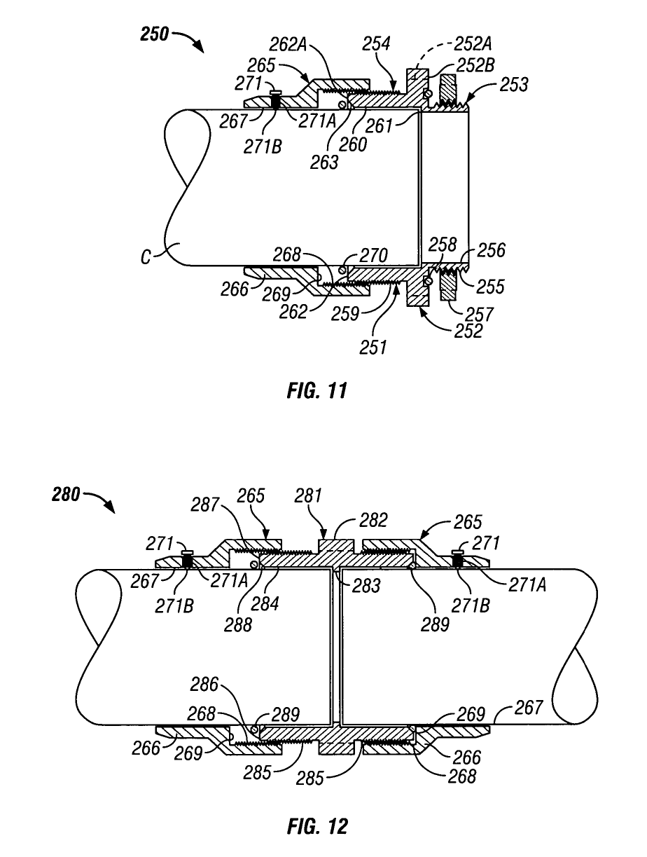

FIG. 11 illustrates a very desirable embodiment of the invention for a connector 250 because is it easy to construct and can be assembled quickly in the field. This connector includes a simple hollow cylindrical housing 251 having a central radial flange 252, with wrench flats 252A. Extending from this flange is a boss 253 on one side and a sleeve 254 on the other. The boss includes external threads 255 on its surface and a bore 256 enabling the boss to be inserted in to an aperture in a junction box (not shown) and thereafter a nut 257 can be screwed on to the boss from inside the box to draw the radial face 252B for the flange against the surface of the box compressing the O-ring 258 on this face against the box to effect a seal. Of course a rubber washer or other sealing device can be used in place of the O-ring.

The surface of the sleeve 254 is provided with threads 259 and its bore 260, which is coaxially with the bore in the boss, is slightly larger than the latter forming a step or stop 261 at their conjunction. As the bore in the sleeve is sized to receive the OD of a conduit C this stop will limit the travel of the end of the conduit into the connector. The distal end 262 of the sleeve is provided with a radial face 262A and a 45 degree relief 263 is provided at the mouth of the bore in the sleeve.

A sleeve cap 265 cooperates with the housing to complete the connector. Its cylindrical body 266 includes two coaxial bores, the smaller of which, bore 267, is sized to slide over a conduit C assembled with the connector and the larger, bore 268, provides internal threads enabling the cap to screwed onto the threads 259 on the sleeve 254 of the housing. At the conjunction of these two bores in the central portion of the housing, a radial face 269 is formed. By assembling the cap in the conduit to be joined with the novel connector, followed by an O-ring 270, the end of the conduit can be inserted into the sleeve of the housing and the cap advanced by its internal threads mating with the external threads on the sleeve. As this occurs the O-ring will be driven into the recess 263 by the radial face in the cap to create a seal between the housing and the conduit. As described above, the internal threads and external threads are designed to have an interference mating, so that the cap will be adequately secured to the housing when its radial face hits the end 262 of the sleeve.

At this time a tap screw 271 or the like in a threaded bore 271A, intersecting the smaller bore 267 in the cap 265, can be advanced so its distal end 271b engages the conduit C locking it in the connector. If desired the cap can include wrench flats (not shown) for tightening it on the connector.

FIG. 12 illustrates the coupling version of the embodiment of the invention illustrated in FIG. 11. This coupling 280 uses the same sleeve cap 265 that has been described in reference to the connector 250 but requires two of these caps, one at each end of the coupling. In view thereof the caps will not be described in detail in reference to this embodiment.

Coupling 280 has a simple tubular housing 281 having a central flange 282 which can include wrench flats (not shown) and a divider 283 in its central bore 284 which forms a stop for the ends of the conduits C joined with the coupling. While the divider in FIG. 12 is shown as an integral part of the housing, it can be replaced by forming a groove in the bore and inserting a snap ring (not shown) to simplify the construction of the housing. The sleeve portions 285 of the housing on opposite sides of the flange 282 are provided with external threads which mate with the internal threads in the caps 265 when they are screwed on the housing. The distal ends 286 of the housing have a radial faces 287 which have 45 degree reliefs 288 at the mouths of bore 284 at each end.

As illustrated in FIG. 12 the caps are assembled on the conduits C followed by a O-ring 289 and then the respective ends of the conduits to be joined end to end are inserted into the housing. Once this assembly has been completed, the caps are advanced on the threaded sleeve portions to compress the O-rings against their respective conduits to effect a seal with interference fit of the threads securing the caps on the housing. When this has been completed, screws 271 are advanced until their respective ends 271B engage the associated conduits locking them in the coupling.

The various embodiments are described by way of illustration and not by way of limitation.

Having described my invention, I claim:

1. A water tight fitting for joining unthreaded electrical conduits to other components comprising:
a circular housing having a bore operable to receive the end of a conduit to be joined with another component by said fitting;
at least one screw means associated with said fitting operable to engage said end of a conduit inserted in such bore to lock the same in said fitting;
at least one compression means having an aperture enabling it to slide freely along such conduit and operable to engage said housing in a manner that said compression means is advanced axially along such conduit in said housing; and
sealing means positioned between said compression means and said housing operable to effect a water tight seal between said housing and such conduit when said compressing means compresses said sealing means as it is advanced axially toward said housing.

2. The water tight fitting described in claim 1 wherein a plurality of screw means are employed with the fitting to lock the conduit in said fitting.

3. The water tight fitting described in claim 1 wherein each screw means is mounted in the housing and includes a seal between said screw means and said housing operable to form a water tight seal between said housing and said screw means.

4. The water tight fitting described in claim 3 wherein the screw means are located in the housing.

5. The water tight fitting described in claim 1 wherein the screw means are located in the compression means.

6. The water tight fitting described in claim 1 wherein the housing has a bevel about the mouth of the bore which receives an end of a conduit in which the sealing means is compressed by the compression means when it is axially advanced in said housing.

7. The water tight fitting described in claim 1 wherein the sealing means is an O-ring.

8. The water tight fitting described in claim 1 wherein the fitting has a threaded boss at one end operable to join said fitting to a junction box.

9. The water tight fitting described in claim 1, wherein the circular bore is open at both ends and each end thereof is operable to receive the end of a conduit therein and separate screw means associated with each end of said housing and operable to lock the respective ends of conduits in said fitting for joining conduits end-to-end.

10. The watertight fitting described in claim 1 where in the compression means is coupled to the housing by an interrupted screw arrangement whereby said compression means need be rotated less than a revolution to compress the sealing means,

11 The wartertight fitting described in claim 1 wherein the compression means is coupled to the housing by threads in said housing and mating threads in said compression means whereby rotating said compression means is operable to axially advance it in said housing.

12 The watertight fitting described in claim 11 wherein the mating threads have an interference fit operable to mechanically lock the compression means against counter rotation after it is advance in the housing and the screw means is located in the compression means.
